(19) United States
(12) Patent Application Publication
(10) Pub. No.: US 2010/0210390 A1
(43) Pub. Date: Aug. 19, 2010

(54) Limited Slip Differential with Electrohydraulic Clutch Actuator

(76) Inventors: Todd Ekonen, Howell, MI (US); Christopher Noullet, Troy, MI (US)

Correspondence Address: MAGNA INTERNATIONAL, INC., 337 MAGNA DRIVE, AURORA, ON, L4G-7K1, CA

(21) Appl. No.: 12/377,332

(22) PCT Filed: Aug. 8, 2007
(86) PCT No.: PCT/US07/17607

§ 371 Date: Feb. 12, 2009

Related U.S. Application Data
(60) Provisional application No. 60/837,969, filed on Aug. 16, 2006.

(51) Int. Cl. F16H 48/22

(52) U.S. Cl. 475/86; 475/220

(57) ABSTRACT

A power transfer device for a front wheel drive motor vehicle includes an input shaft driven by a power source, a second shaft driven by the first shaft through one of a plurality of speed gearsets, an output gearset driven by the second shaft and a differential assembly. The differential assembly includes an electronically controlled, hydraulically actuated, clutch operable to place the differential assembly in one of an open mode, a locked mode and a limited slip mode. A clutch actuator includes an electric motor coupled to a pump where the pump provides pressurized fluid to the clutch to operate the clutch in one of the locked and limited slip modes.

### BACKGROUND

The present disclosure relates generally to limited slip differential assemblies for use in motor vehicles. More particularly, the present disclosure relates to an electronically controlled, hydraulically actuated limited slip differential assembly.

Currently, higher horsepower front wheel drive vehicles are being introduced into the marketplace. These vehicles typically benefit from the use of a limited slip device in the front axle differential to help transfer the available power to both of the front driver wheels. Some known vehicles are equipped with passive mechanical limited slip differentials to improve tractive effort and vehicle handling. While such strategies generally work in a satisfactory manner, a need for an improved limited slip differential device assembly exists.

### SUMMARY OF THE INVENTION

The present disclosure relates to a power transmission device for a front wheel drive motor vehicle having an input shaft driven by a power source, a second shaft driven by the first shaft through one of a plurality of speed gearsets, an output gearset driven by the second shaft and a differential assembly. The differential assembly includes an electronically controlled, hydraulically actuated, clutch operable to place the differential assembly in one of an open mode, a locked mode and a limited slip mode. A clutch actuator includes an electric motor coupled to a pump where the pump provides pressurized fluid to the clutch to operate the clutch in one of the locked and limited slip modes.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The disclosure will now be described, by way of example, with reference to the accompanying drawings in which:

FIG. 1 is a schematic illustrating the drivetrain of a motor vehicle equipped with a hydraulically actuated front electronic limited slip differential assembly of the present disclosure;

FIG. 2 is a cross-sectional view of a front transaxle according to the present disclosure;

FIG. 3 is an enlarged partial cross-sectional view of the electronic limited slip differential assembly associated with the drivetrain shown in FIG. 1 and the front transaxle shown in FIG. 2;

FIG. 4 is a schematic of an electro-hydraulic actuator associated with the electronic limited slip differential assembly shown in FIGS. 1-3;

FIG. 5 is an exemplary control schematic associated with the electronic limit slip differential assembly of the present disclosure; and

FIG. 6 is a schematic illustrating an alternate vehicle equipped with an alternate drivetrain having a hydraulically actuated electronic limited slip differential assembly of the present disclosure.

### DETAILED DESCRIPTION OF THE PREFERRED EMBODIMENTS

The present disclosure is directed to a hydraulically actuated front electronic limited slip differential assembly for use in a motor vehicle equipped with a transversely mounted engine and transaxle which may be arranged to provide solely front wheel drive capability or alternately front and part-time four-wheel drive modes of operation. The right-angled design provides a compact package which permits use of the front electronic limited slip differential in a wide variety of vehicles.

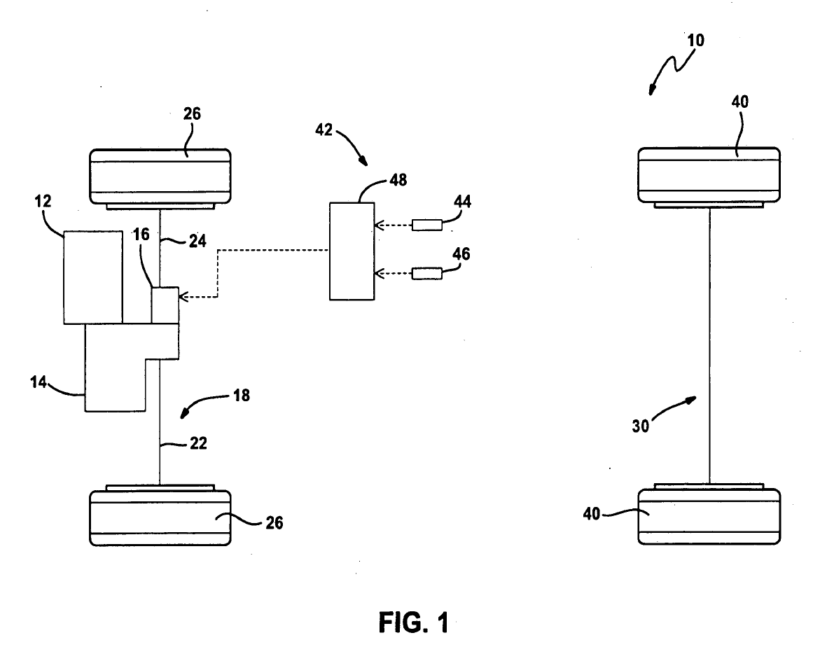

With particular reference to FIG. 1, a schematic of a motor vehicle 10 is shown to include a transversely mounted engine 12 and a power transmission device such as a transaxle 14 adapted to deliver motive power (i.e., drive torque) to the input of a hydraulically actuated front electronic limited slip differential assembly (FELSDA) 16. FELSDA 16 is depicted in a front-wheel drive application operable to transfer drive torque to a front driveline 18. Front driveline 18 includes a first output or left half-shaft 22 and a second output or right half-shaft 24. Half-shafts 22 & 24 are connected to a pair of ground-engaging wheels 26. A rear axle assembly 30 includes a pair of ground-engaging wheels 40.

Motor vehicle 10 further includes an electronic control system 42. Electronic control system 42 includes a plurality of vehicle sensors 44 and system sensors 46 for detecting various operational and dynamic characteristics of vehicle 10. Vehicle sensors 44 may detect characteristics such as throttle position, throttle acceleration, wheel speeds, shaft speeds, among other vehicle operating characteristics. System sensors 46 may detect FELSDA system parameters such as clutch application pressure, pump fluid temperature, as well as other system characteristics. Sensors 44 and 46 relay operational and dynamic information to an electronic control unit (ECU) 48. ECU 48 can provide various outputs, including operational control of FELSDA 16.

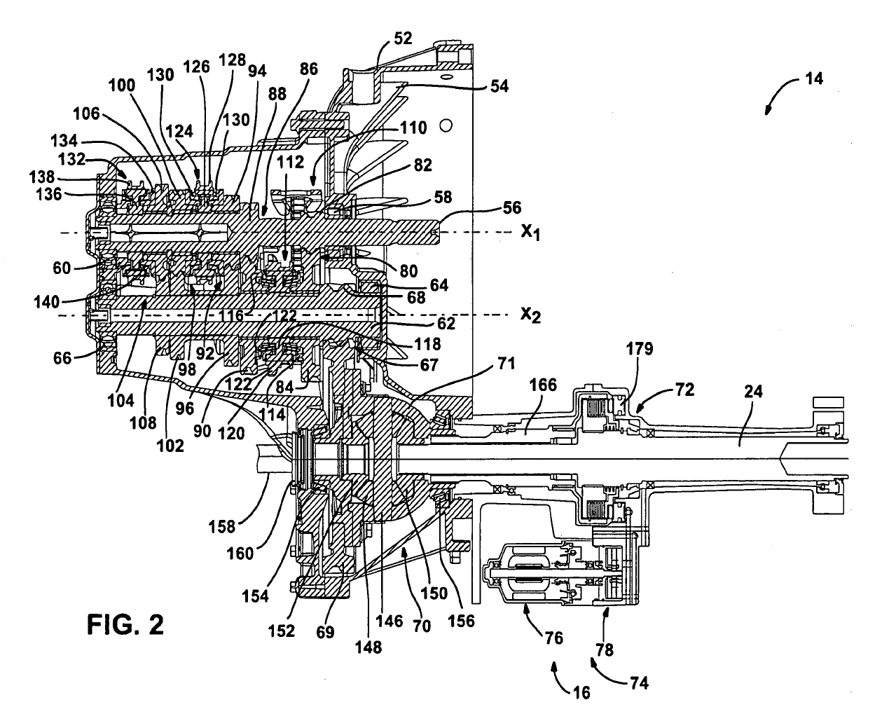

With particular reference to FIG. 2 of the drawings, transaxle 14 is shown to include a housing 52 structurally reinforced by a set of inner ribs 54. An input shaft 56 is rotatably supported by a first bearing 58 and a second bearing 60 within housing 52. Input shaft 56 is rotatable about an axis X₁. Input shaft 56 is adapted to be driven by engine 12. Transaxle 14 also includes an output shaft 62 rotatably supported within housing 52 by a third bearing 64 and a fourth bearing 66 for rotation about an axis X₂. Axes X₁ and X₂ are positioned parallel to one another. Transaxle 14 includes a plurality of constant-mesh gearsets operable to establish different drive ratios between input shaft 56 and output shaft 62. The gearsets will be described in greater detail herein.

An output gearset 67 includes an output drive gear 68 fixed to output shaft 62 in constant mesh engagement with an output driven gear 69. Output driven gear 69 provides drive torque to a housing 71 of a front differential assembly 70. FELSDA 16 further includes a wet clutch 72 operated by an actuator assembly 74. Actuator assembly 74 is electronically operated by electronic control unit 48.

Wet clutch 72 is operable to selectively restrict rotation of right half shaft 24 relative to differential housing 71 to provide a desired torque split within front differential assembly 70 such as when one of front wheels 26 loses the ability to transfer torque to the ground, for example, due to low mu. Electronic control system 42, based on vehicle characteristic information detected by sensors 44 and 46 analyzed by electronic control unit 48, automatically and adaptively controls a motor 76 of actuator assembly 74. Motor 76 operates a pump 78 to selectively apply an activation force to wet clutch 72 such that a desired torque split is transferred through front differential assembly 70. A particularly useful feature of this system is that wet clutch 72 may be partially or fully locked prior to vehicle movement based on a preemptive control strategy implemented by electronic control unit 48. Furthermore, this system is not limited in bias ratio and can modulate the torque transfer across ground engaging wheels 26 to mitigate impulses into the steering system.

Transaxle 14 includes a series of constant-mesh gearsets that can be selectively engaged for establishing five forward speed ratios as well as a reverse speed ratio between input shaft 56 and output shaft 62. In this regard, a first gearset 80 includes a first drive gear 82 formed on input shaft 56 and a first speed gear 84 rotatably supported on output shaft 62. First speed gear 84 is in constant mesh with first drive gear 82 for defining a first power transmission path that can be selectively engaged to establish a first forward speed ratio.

A second gearset 86 includes a second drive gear 88 formed on input shaft 56 that is in constant mesh with a second speed gear 90 rotatably supported on output shaft 62. Thus, second gearset 86 defines a second power transmission path that can be selectively engaged to establish a second forward speed ratio. A third gearset 92 includes a third drive gear 94 rotatably supported on input shaft 56 that is in constant mesh with a third speed gear 96 rotatably fixed on output shaft 62. As such, third gearset 92 defines a third power transmission path that can be selectively engaged to establish a third forward speed ratio. A fourth gearset 98 includes a fourth drive gear 100 rotatably supported on input shaft 56 that is in constant mesh with a fourth speed gear 102 rotatably fixed on output shaft 62. Thus, fourth gearset 98 defines a fourth power transmission path that can be selectively engaged to establish a fourth forward speed ratio. A fifth gearset 104 includes a fifth drive gear 106 rotatably supported on input shaft 56 that is in constant mesh with a fifth speed gear 108 rotatably fixed to output shaft 62. Fifth gearset 104 defines a fifth power transmission path that can be selectively engaged to establish a fifth forward speed ratio. Finally, a reverse gearset 110 defines a sixth power transmission path that can be selectively engaged to reverse the direction of rotation of output shaft 62 and establish the reverse speed ratio.

Each gearset is associated with a synchronizer clutch to selectively establish the various forward and reverse speed ratios between input shaft 56 and output shaft 62 by selectively completing one of the six available power transmission paths. In particular, a first synchronizer clutch 112 is operably located between first and second speed gears 84 and 90 and includes a clutch gear 114 fixed to first speed gear 84, a clutch gear 116 fixed to second speed gear 90, a hub 118 fixed to output shaft 62, a shift sleeve 120 mounted for rotation with and axial sliding movement on hub 118, and a pair of synchronizers 122 located between shift sleeve 120 and clutch gears 114 and 116. First synchronizer clutch 112 is of the double-acting variety such that axial movement of shift sleeve 120 from its centered neutral position shown into engagement with clutch gear 114 will releasably couple first speed gear 84 to output shaft 62 for engaging the first power transmission path and establishing the first forward speed ratio. Moreover, axial movement of shift sleeve 120 from its neutral position into engagement with clutch gear 116 will releasably couple second speed gear 90 to output shaft 62 for engaging the second power transmission path and establishing the second forward speed ratio.

To establish the third and fourth forward speed ratios, a second synchronizer clutch 124 is located between third and fourth drive gears 94 and 100 and includes a hub 126 fixed to input shaft 56, a shift sleeve 128 mounted for rotation with and axial sliding movement on hub 126, and a pair of synchronizers 130. Second synchronizer clutch 124 is also of the double-acting type such that movement of shift sleeve 128 from its centered neutral position shown into engagement with third drive gear 94 will releasably couple third drive gear 94 to input shaft 56 for engaging the third power transmission path, thereby driving output shaft 62 through third speed gear 96 for establishing the third forward speed ratio. Similarly, movement of shift sleeve 128 from its neutral position into engagement with fourth drive gear 100 will releasably couple fourth drive gear 100 to input shaft 56 for engaging the fourth power transmission path, thereby driving output shaft 62 through fourth speed gear 102 for establishing the fourth forward speed ratio.

To establish the fifth speed ratio, a third synchronizer clutch 132 is located on input shaft 56 next to fifth drive gear 106 and includes a clutch gear 134 fixed to fifth drive gear 106, a hub 136 fixed to input shaft 56, a shift sleeve 138 mounted for rotation with and axial sliding movement on hub 136, and a synchronizer 140. Sliding movement of shift sleeve 138 from its centered neutral position shown into engagement with clutch gear 134 will releasably couple fifth drive gear 106 to input shaft 56 for engaging the fifth power transmission path, whereby the fifth forward speed ratio is established.

As stated previously, reverse gearset 110 can be selectively engaged to reverse the direction of rotation of output shaft 62 and establish the reverse speed ratio. When any one of gearsets 80, 86, 92, 98, 104 or 110 is selected, drive torque is delivered from input shaft 56 through one of the speed gearsets and through output gearset 67. Output driven gear 69 is fixed to housing 71. As such, differential assembly 70 is in constant driving engagement with output shaft 62.

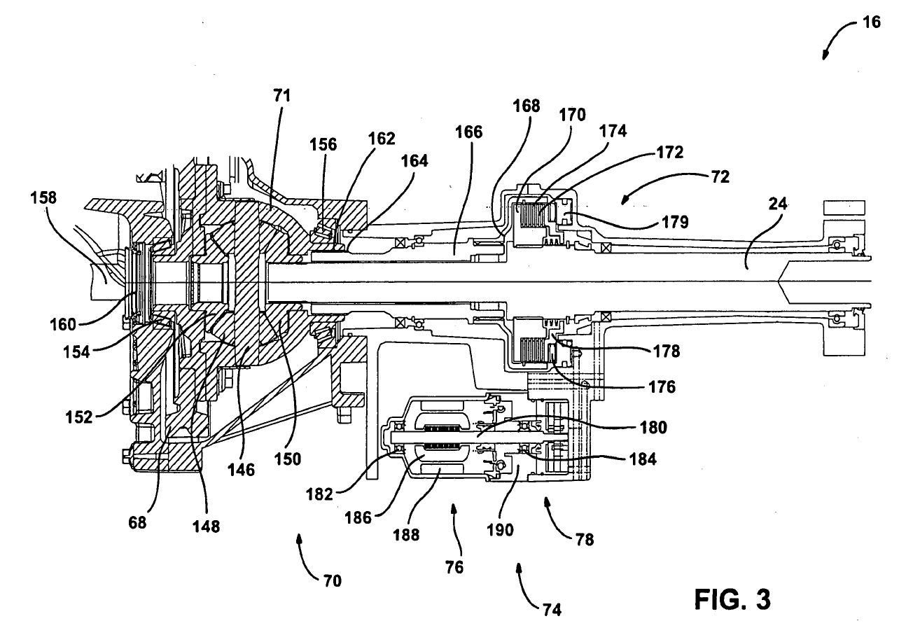

Referring now to FIGS. 2 and 3, front differential assembly 70 of FELSDA 16 further includes a pinion shaft 146, a pair of pinion gears 148, a first output side gear 150, and a second output side gear 152. Housing 71 is rotatably supported in transaxle housing 52 by a fifth bearing 154 and a sixth bearing 156. Pinion gears 148 are rotatably supported on pinion shaft 146. Pinion shaft 146 is secured to differential housing 71. Each pinion gear 148 is in meshed engagement with first output side gear 150 and second output side gear 152. First output side gear 150 is splined for connection with an input end of right half-shaft 24. Second output side gear 152 is fixed for rotation with an input end of a stub shaft 158. A seal assembly 160 engages stub shaft 158 to prevent ingress of contamination. Stub shaft 158 is drivingly connected to left half-shaft 22 (FIG. 1).

Front differential housing 71 includes a set of internal splines 162 in continuous engagement with a set of external splines 164 formed on a transfer shaft 166. Transfer shaft 166 is fixed for rotation with a drum 168 of wet clutch 72. Wet clutch 72 further includes a hub 170 fixed for rotation with right half-shaft 24, a set of outer clutch plates 172, a set of inner clutch plates 174, a thrust bearing 176 and an actuator plate 178. Inner clutch plates 174 are splined for rotation with hub 170 and interleaved with outer clutch plates 172 splined for rotation with drum 168.

A piston 179 is in communication with pressurized fluid provided by pump 78. Piston 179 acts on actuator plate 178 through thrust bearing 176 to apply a clutch engagement force on plates 172 and 174 to transfer drive torque through wet clutch 72. Wet clutch 72 may be controlled to operate differential assembly 70 in an open mode, a locked mode or a limited slip mode where a desired torque split is provided.

As previously mentioned, FELSDA 16 includes actuator assembly 74 to apply pressurized fluid to piston 179. In the particular embodiment shown, motor 76 is an electric motor and pump 78 is a constant displacement pump. Variations of these components may be substituted to provide similar functions. Motor 76 includes an output shaft 180 rotatably supported on a seventh bearing 182 and an eighth bearing 184 as well as a rotor 186 and a stator 188. FIG. 3 further depicts an end cap 190 located to separate motor 76 from pump 78.

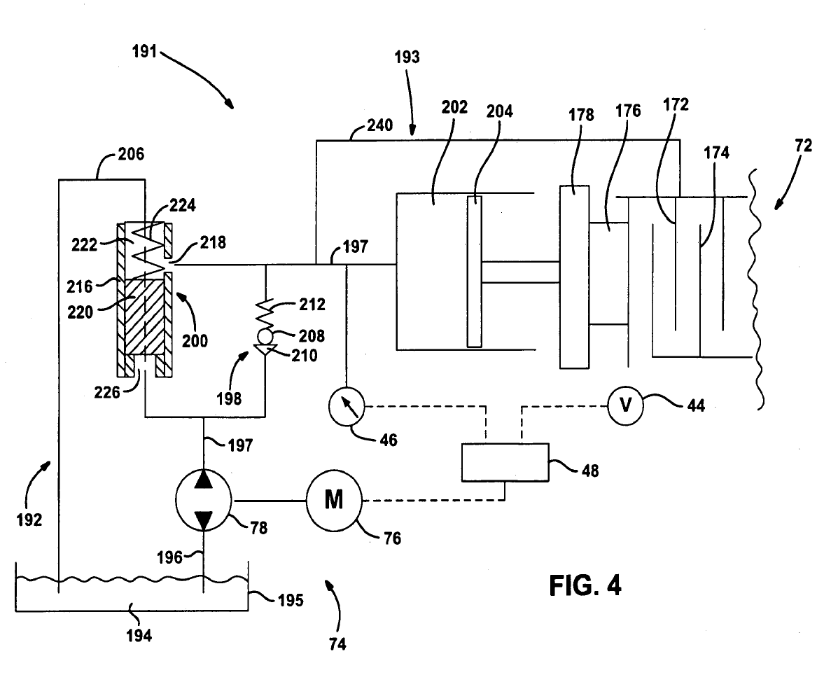

FIG. 4 schematically depicts actuator assembly 74 in communication with a clutch application and lubrication system 191. System 191 includes a clutch application and control portion 192 and a lubrication portion 193.

Clutch application and control portion 192 includes motor 76 operating pump 78 to draw a fluid 194 from a sump 195, a suction line 196, a supply line 197, a non-return valve 198, an optional dump valve 200, a pressure chamber 202, and a return line 206. Non-return valve 198 contains a ball 208 that is pressed against a seat 210 by a spring 212. Dump valve 200 is formed by a sleeve 216 with at least one opening 218, which communicates with pressure chamber 202 through supply line 197, and by a valve piston 220 capable of being displaced in sleeve 216. Valve piston 220 separates a first chamber 222 containing a spring 224 from a second chamber 226. First chamber 222 communicates with sump 195 through return line 206. Supply line 197 branches to connect pump 78 to second chamber 226 and provide pressurized fluid to non-return valve 198 and pressure chamber 202.

When an open differential condition is desired, electronic control unit 48 causes motor 76 to remain at rest. If output shaft 180 of motor 76 is not rotating, pump 78 provides insufficient pressure to cause non-return valve 198 to open or dump valve 200 to close. As such, little to no pressure is present in pressure chamber 202 and wet clutch 72 accordingly does not transmit torque. When a locked differential or limited slip mode is desired, electronic control unit 48 signals motor 76 to operate. Fluid 194 is drawn through suction line 196 into pump 78 upon energization of motor 76. Pressurized fluid enters supply line 197 with a pressure large enough to overcome the force of spring 224. Valve piston 220 is translated to a position closing opening 218. The force of spring 212 is such that non-return valve 198 does not open until opening 218 is fully closed. At this point, fluid 194 flows into pressure chamber 202 to apply force to piston 204 and activate wet clutch 72.

Pressure may be maintained in pressure chamber 202 for an extended time while output shaft 180 is rotating at a relatively low speed if sealing is effective. Furthermore, during stationary operation with wet clutch 72 engaged, actuator assembly 74 only needs to maintain sufficient pressure for valve piston 220 to remain closed. Thus, delivery quantity is almost zero, since any leakage takes place for the most part in the interior of pump 78. Considerable energy savings are achieved by this means.

If pump 78 is brought to a halt, pressure on valve piston 220 decreases. From this pressure decrease, spring 224 forcibly returns valve piston 220 to a position where opening 218 re-opens and fluid 194 is able to escape from pressure chamber 202 into sump 195. If actuator assembly 74 is reversed, reversing the direction of supply of fluid 194, pump 78 feeds sump 195 with fluid 194 drawn through supply line 197. In this situation, a partial vacuum will be produced under valve piston 220 causing it to accelerate significantly toward the position where opening 218 is clear. Wet clutch 72 will then be fully and instantaneously disengaged stopping torque transfer.

FIG. 4 further depicts lubrication portion 193 providing fluid 194 to clutch 72 for cooling. In particular, lubrication portion 193 includes a lubrication line 240 branched off of supply line 197. In this manner lubrication and cooling fluid is provided to clutch 72 while it is in operation.

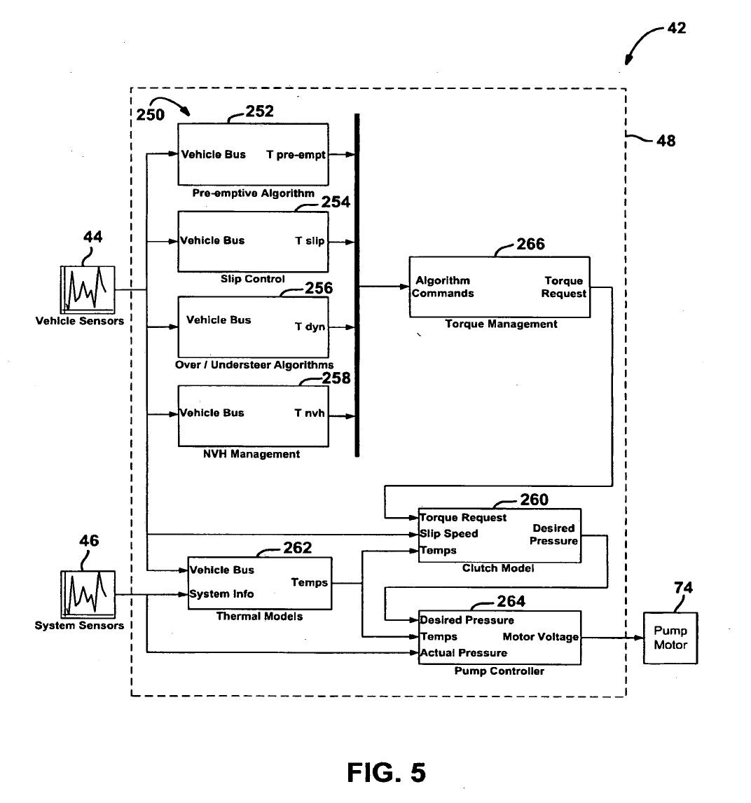

FIG. 5 depicts an exemplary control diagram for electronic control system 42. Vehicle sensors 44 detect a plurality of vehicle characteristics and input the information to various input algorithms 250 of electronic control unit 48. The input algorithms 250 may include, but are not limited to, a pre-emptive algorithm 252, a slip control algorithm 254, an over/under-steer algorithm 256, and a noise, vibration and harshness (NVH) management algorithm 258. Vehicle sensors 44 further input information to a clutch model algorithm 260 and a thermal model algorithm 262. System sensors 46 are also in communication with electronic control unit 48 and may input system information to thermal model algorithm 262 and a pump controller algorithm 264.

The input algorithms 250 output various signals to a torque management algorithm 266. Torque management algorithm 266 outputs a torque request to clutch model algorithm 260. With vehicle information and system information from sensors 44 and 46, thermal model algorithm 262 outputs temperature signals to both clutch model algorithm 260 and pump controller algorithm 264. From the torque request provided by torque management algorithm 266, the slip speed from vehicle sensor 44, and temperature signal thermal model algorithm 262, clutch model algorithm 260 outputs a desired pressure to pump controller algorithm 264. With the desired pressure signal, along with the temperature signal from thermal model algorithm 262 and an actual pressure measurement signal from system sensors 46, pump controller algorithm outputs a motor voltage to actuator assembly 74 to actuate wet clutch 72 accordingly.

For example, a particular vehicle sensor 44 can measure throttle position and acceleration. This information along with other vehicle and system information detected by sensors 44 and 46 are input into electronic control unit 48 to determine an appropriate motor voltage to relay to actuator assembly 74. If the throttle position and acceleration data suggests that it may be beneficial to enter into the limited slip or fully locked mode of differentiation, a voltage will be provided to operate motor 76 which will drive pump 78 to force fluid 194 into pressure chamber 202 causing piston 179 to apply a clutch engagement force. This engagement force causes outer plates 172 and inner plates 174 to frictionally engage one another and transfer torque through wet clutch 72. Relative rotation between housing 71 of front differential assembly 70 and half-shaft 24 is restricted. Thus, in this exemplary situation, FELDSA 16 is electronically operated to preemptively place FELDSA 16 in a limited slip or fully locked mode before any wheel slippage occurs. This control scheme greatly improves vehicle stability because the system is not tasked to react or correct an unstable vehicle condition but addresses a potential for instability.

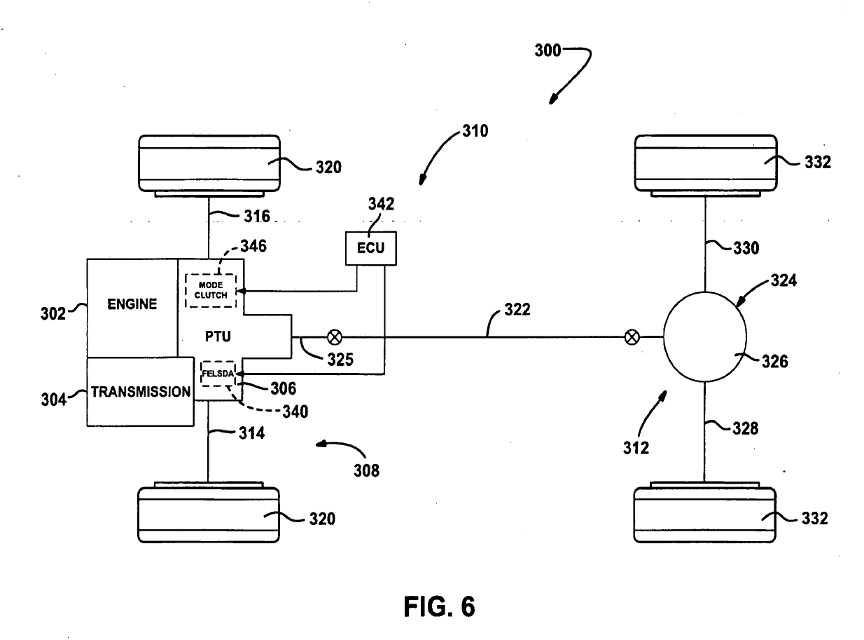

FIG. 6 depicts an alternate vehicle 300 equipped with an alternate drivetrain arrangement. In particular, motor vehicle 300 includes a transversely mounted engine 302 and a multi-speed transmission 304 adapted to deliver power to the input of a power transmission device such as a power take-off unit (PTU) 306. PTU 306 is normally operable to deliver drive torque to a first driveline 308 and works in conjunction with a power transfer system 310 to selectively transfer drive torque to a second driveline 312. First driveline 308 includes a pair of axle shafts 314 and 316 connected to a pair of ground engaging wheels 320. Second driveline 312 includes driveshaft 322 and an axle assembly 324. One end of driveshaft 322 is connected to an output member 325 of PTU 306 and its opposite end is connected to a differential 326 associated with axle assembly 324. Axle assembly 324 includes a pair of axle shafts 328 and 330 which connect a pair of ground engaging wheels 332 to differential 326.

PTU 306 includes an electronically controlled, hydraulically actuated limited slip differential assembly (FELSDA) 340. FELSDA 340 operates substantially similarly to FELSDA 16 previously described in detail. FELSDA 340 is in communication with an electronic controller unit 342. Accordingly, one skilled in the art will appreciate that FELSDA 340 is controllable to selectively place the front axle differential in one of an open mode, a locked mode and a limited slip differential mode.

PTU 306 also includes a mode clutch 346 selectively operable to transfer drive torque to driveshaft 322. Mode clutch 346 is also controlled by controller 342 such that vehicle 300 can be placed in a two wheel drive mode or a part-time four wheel drive operating mode.

Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A power transfer device for a front wheel drive motor vehicle having first and second driven front wheels, the power transfer device comprising:
an input shaft adapted to be driven by a power source;
a second shaft driven by said first shaft through one of a plurality of speed gearsets;
an output gearset driven by said second shaft;
a differential assembly drivingly coupled to said output gearset, said differential assembly including a housing rotatably supported within said power transfer device, a pair of pinion gears rotatably supported by said housing and a pair of side gears, each side gear being in meshed engagement with said pinion gears;
first and second axle shafts being individually driven by said side gears;
an electronically controlled, hydraulically actuated clutch selectively drivingly interconnecting said first axle shaft and said differential housing to place said differential assembly in one of an open mode, a locked mode and a limited slip mode; and
a clutch actuator having an electric motor coupled to a pump, said pump providing pressurized fluid to said clutch to operate said differential assembly in one of said locked and limited slip modes.

2. The power transfer device of claim 1 further including a controller operable to determine impending slip of said first and second wheels and preemptively operating said clutch actuator to prevent first and second wheel slip.

3. The power transfer device of claim 2 wherein said controller determines impending slip based on information provided by a vehicle sensor.

4. The power transfer device of claim 3 wherein said vehicle sensor includes at least one of a vehicle throttle position sensor and a vehicle acceleration sensor.

5. The power transfer device of claim 1 wherein said first and second axle shafts rotate about an axis substantially parallel to and offset from an axis of rotation of said input shaft.

6. The power transfer device of claim 5 wherein said second shaft rotates about an axis substantially parallel to and offset from said input shaft axis.

7. The power transfer device of claim 1 further including a rotatable output member selectively driven by said input shaft and adapted to transfer torque to a set of driven rear wheels.

8. The power transfer device of claim 7 further including a mode clutch selectively operable to transfer torque to said output member.

9. The power transfer device of claim 1 wherein said output gearset includes a first gear driven by said second shaft and a second gear fixed to said differential housing.

10. A power transfer device for a motor vehicle having first and second driven wheels, the power transfer device comprising:
a rotatable input shaft;
a second shaft driven by said first shaft through one of a plurality of speed gearsets;
a differential assembly being driven by said second shaft, said differential assembly including a housing rotatably supported within said power transfer device, a pair of pinion gears supported for rotation within said housing and a pair of side gears, each side gear being in meshed engagement with said pinion gears;
first and second axle shafts being individually driven by said side gears;
a tubular transfer shaft fixed for rotation with said differential and at least partially encompassing said first axle shaft; and
a clutch selectively drivingly interconnecting said first axle shaft and said transfer shaft to place said differential assembly in one of an open mode, a locked mode and a limited slip mode.

11. The power transfer device of claim 10 further including a clutch actuator having an electric motor coupled to a pump, said pump providing pressurized fluid to said clutch to operate said differential assembly in one of said locked and limited slip modes.

12. The power transfer device of claim 11 wherein said clutch includes a drum fixed for rotation with said transfer shaft and a hub fixed for rotation with said first axle shaft.

13. The power transfer device of claim 12 further including a power transfer device housing having each of said input shaft, said second shaft, said differential assembly, said transfer shaft, said clutch and at least a portion of said first axle shaft positioned therein.

14. The power transfer device of claim 13 wherein said power transfer device housing contains lubricant and said clutch is a wet clutch positioned in contact with said lubricant.

15. The power transfer device of claim 11 wherein said electric motor has an output shaft rotating about an axis extending parallel to an axis of rotation of said first axle shaft.

16. The power transfer device of claim 11 wherein said clutch actuator includes a piston slidably positioned within a cavity to apply a force to said clutch.

17. The power transfer device of claim 11 further including a valve biased toward an open position to release pressurized fluid acting on said piston.

18. The power transfer device of claim 17 wherein said valve is moved to a closed position when said pump is actuated to trap pressurized fluid with said cavity and actuate said, clutch.

19. The power transfer device of claim 18 wherein deactivation of said pump causes said valve to move to said open position to rapidly deactivate said clutch.

20. The power transfer device of claim 10 further including a rotatable output member selectively driven by said input shaft and adapted to transfer torque to a set of driven rear wheels.
